(19) United States
(12) Patent Application Publication
(10) Pub. No.: US 2013/0324185 A1
(43) Pub. Date: Dec. 5, 2013

(54) Mode Switching Method and Device

(71) Applicant: Huawei Device Co., Ltd., Shenzhen (CN)

(72) Inventor: Xiaopeng Zhang, Xi'an (CN)

(21) Appl. No.: 13/891,361

(22) Filed: May 10, 2013

(30) Foreign Application Priority Data
May 17, 2012 (CN) 201210153983.3

(51) Int. Cl. H04W 88/06

(52) U.S. Cl. CPC H04W 88/06
USPC 455/552.1

(57) ABSTRACT

The present invention discloses a mode switching method and device. The technical solution of the present invention includes: receiving a first switching instruction for switching a working mode of a terminal to target mode; switching the working mode of the terminal to the target mode according to the first switching instruction, where the target mode indicates that a circuit switch CS domain service is in a disconnected state, and a packet switch PS domain service is in a connected state. Embodiments of the present invention are mainly applied in a mode switching process and solve the problem that when a terminal is switched to an offline mode, the terminal is in a power-off state relative to a network, so in addition to that calls and short messages in a CS domain service cannot be received, network data services in a PS domain service cannot be used as well.

### CROSS-REFERENCE TO RELATED APPLICATIONS

This application claims priority to Chinese Patent Application No. 201210153983.3, filed on May 17, 2012, which is hereby incorporated by reference in its entirety.

### FIELD OF THE INVENTION

The present invention relates to the field of terminal technologies, and in particular, to a mode switching method and device.

### BACKGROUND OF THE INVENTION

When a user does not want to receive calls or short messages, the user switches the mode of a mobile phone to an offline mode, so as to be free from answering calls or receiving short messages. In this case, the mobile phone is incapable of performing services in a CS (Circuit Switch, circuit switch) domain and a PS (Packet Switch) domain. Voice and short message services are managed in the CS domain, and data services, such as Internet access and stream media services, are managed in the PS domain.

After research, it is found that, when the mobile phone is switched to an offline mode, the mobile phone is in a power-off state relative to the network, so in addition to that calls and short messages in a CS domain service cannot be received, network data services in a PS domain service cannot be used as well.

### SUMMARY OF THE INVENTION

Embodiments of the present invention provide a mode switching method and device, which implement that network data services may be used when a terminal is incapable of receiving calls and short messages, thereby improving service experience of users.

In order to achieve the above objective, the present invention adopts the following technical solutions:

A mode switching method, including:

receiving a first switching instruction for switching a working mode of a terminal to a target mode; and

switching the working mode of the terminal to the target mode according to the first switching instruction, where the target mode indicates that a circuit switch CS domain service is in a disconnected state, and a packet switch PS domain service is in a connected state.

A terminal, including:

a receiving unit, configured to receive a first switching instruction for switching a working mode of a terminal to a target mode; and

a processing unit, configured to switch the working mode of the terminal to the target mode according to the first switching instruction, where the target mode indicates that a circuit switch CS domain service is in a disconnected state, and a packet switch PS domain service is in a connected state.

In the mode switching method and device provided in the embodiments of the present invention, when a first switching instruction for switching a working mode of a terminal to a target mode is received, the working mode of the terminal is switched to the target mode, where the target mode indicates that a circuit switch CS domain service is in a disconnected state, and a packet switch PS domain service is in a connected state. The embodiments of the present invention solve the problem in the prior art that when a terminal is switched to an offline mode, in addition to that calls and short messages in a CS domain service cannot be received, network data services in a PS domain service cannot be used as well because the terminal is in a power-off state relative to a network, and implement that the terminal is capable of using network data services when being incapable of receiving calls or short messages, thereby improving service experience of users.

### BRIEF DESCRIPTION OF THE DRAWINGS

FIG. 1 is a flow chart of a mode switching method according to Embodiment 1 of the present invention;

FIG. 2 is a flow chart of another mode switching method according to Embodiment 1 of the present invention;

FIG. 3 is a flow chart of still another mode switching method according to Embodiment 1 of the present invention;

FIG. 4 is a flow chart of still another mode switching method according to Embodiment 1 of the present invention;

FIG. 5 is a flow chart of still another mode switching method according to Embodiment 1 of the present invention;

FIG. 6 is a structural diagram of a terminal according to Embodiment 2 of the present invention;

FIG. 7 is a structural diagram of a processing unit in a terminal according to Embodiment 2 of the present invention;

FIG. 8 is a structural diagram of another processing unit in a terminal according to Embodiment 2 of the present invention; and

FIG. 9 is a structural diagram of still another processing unit in a terminal according to Embodiment 2 of the present invention.

### DETAILED DESCRIPTION OF THE EMBODIMENTS

A mode switching method and device according to the embodiment of the present invention are described in detail below with reference to the accompanying drawings.

### Embodiment 1

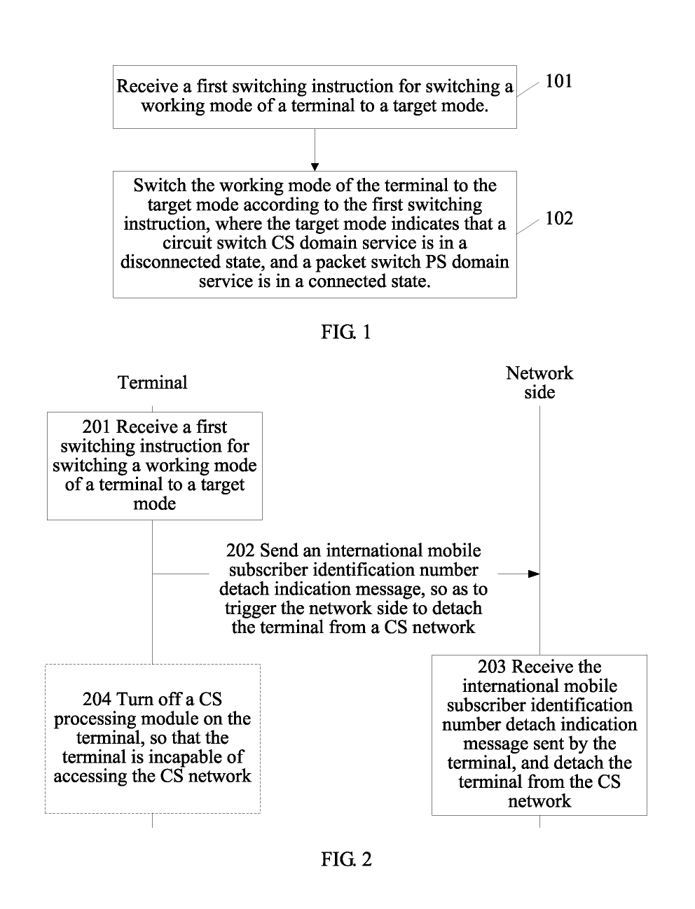

As shown in FIG. 1, a mode switching method according to an embodiment of the present invention specifically includes the following steps:

101: Receive a first switching instruction for switching a working mode of a terminal to a target mode.

102: Switch the working mode of the terminal to the target mode according to the first switching instruction, where the target mode indicates that a circuit switch CS domain service is in a disconnected state, and a packet switch PS domain service is in a connected state.

In the mode switching method according to an embodiment of the present invention, when a first switching instruction for switching a working mode of a terminal to a target mode is received, the working mode of the terminal is switched to the target mode, where the target mode indicates that a circuit switch CS domain service is in a disconnected state, and a packet switch PS domain service is in a connected state. The embodiment of the present invention solves the problem in the prior art that when a terminal is switched to an offline mode, the terminal is in power-off state relative to a network, so in addition to that calls and short messages in a CS domain service cannot be received, network data services in a PS domain service cannot be used as well, and implements that the terminal is capable of using network data services when being incapable of receiving calls or short messages, thereby improving service experience of users.

An execution subject of the above method is a mobility management module in the terminal. The mobility management module is existing entity hardware on the terminal. The first switching instruction in the above method is first received by an application layer of the terminal, and is sent by the application layer of the terminal to the mobility management module of the terminal, so that the mobility management module of the terminal receives the first switching instruction. Then, through a specific operation of the mobility management module of the terminal, the working mode of the terminal is switched to the target mode.

FIG. 2 shows a mode switching method according to another embodiment of the present invention. In a specific application, for example, before the working mode of the terminal is switched to the target mode, if the working mode of the terminal is a first mode, where the first mode indicates that the CS domain service is in a connected state, and the PS domain service is in a connected state, the mode switching method specifically includes the following steps:

201: Receive a first switching instruction for switching a working mode of a terminal to a target mode.

Exemplarily, an option or an icon corresponding to the target mode may be added in a keyboard, a touchscreen or an interface menu of the terminal, where the option or the icon is used to generate a first switching instruction input by a user when the user clicks the option or icon corresponding to the target mode, so that the application layer of the terminal receives the first switching instruction. The application layer of the terminal sends the first switching instruction to the mobility management module of the terminal, so that the mobility management module of the terminal receives the first switching instruction, so as to set the working mode of the terminal to the target mode.

Optionally, an option may further be added in a setting menu of the terminal, where the option is used to generate a first switching instruction input by a user when the user selects the option, so that the application layer of the terminal receives the first switching instruction. The application layer of the terminal sends the first switching instruction to the mobility management module of the terminal, so that the mobility management module of the terminal receives the first switching instruction and detaches the terminal from a CS network. In other words, a CS domain service of the terminal is in a disconnected state, and a PS domain service is in a connected state, that is, the working mode of the terminal is set to the target mode.

An execution subject of this step is the mobility management module, which is existing entity hardware on the terminal.

202: The terminal sends an international mobile subscriber identification number detach indication message to a network side, so as to trigger the network side to detach the terminal from a CS network.

Specifically, the mobility management module of the terminal sends an international mobile subscriber identification number detach indication (International Mobile Subscriber Identification Number Detach Indication, IMSI Detach Indication) message to the network side, so as to trigger the network side to detach the terminal from the CS network.

203: The network side receives the international mobile subscriber identification number detach indication message sent by the terminal, and detaches the terminal from the CS network.

After receiving the international mobile subscriber identification number detach indication message sent by the terminal, the network side may detach the terminal from the CS network by using an existing technology.

In the existing technology, when the terminal is switched to an offline mode, while sending an IMSI detach indication message to the network side, the terminal also sends a GPRS (General Packet Radio Service, general packet radio service) detach indication message to the network side, or sends an IMSI and GPRS joint detach indication message to the network side, so that both the CS domain service and the PS domain service of the terminal are in disconnected state, that is, the terminal is incapable of performing the CS domain and PS domain services. However, in the embodiment of the present invention, only an IMSI detach indication message is sent to the network side, so that the CS domain service of the terminal is in disconnected state, while the PS domain service is in connected state, that is, the terminal is incapable of performing the CS domain service, but is still capable of performing the PS domain service.

Optionally, the above steps 202 to 203 may also be replaced by the following step 204:

204: The terminal turns off a CS processing module on the terminal, so that the terminal is incapable of accessing a CS network.

The mobility management module of the terminal turns off the CS processing module on the terminal, and maintains a PS processing module in an on state.

For the network side, the terminal does not send an IMSI detach indication message to the network side, so the network side does not know that the terminal is incapable of performing the CS domain service. When a call is made to the terminal, the network side gets a response indicating that the call cannot be answered.

Through the above method, no matter the terminal sends an international mobile subscriber identification number detach indication message to the network side, or turns off the CS processing module on the terminal, the CS domain service on the terminal is in a disconnected state, and the PS domain service is in a connected state.

In this case, the terminal is incapable of performing the CS domain service such as calls and short messages, but is capable of performing the PS domain service such as web browsing. A user is free from answering calls or receiving short messages, but may still use data services, for example, the PS domain service such as Internet access and stream media.

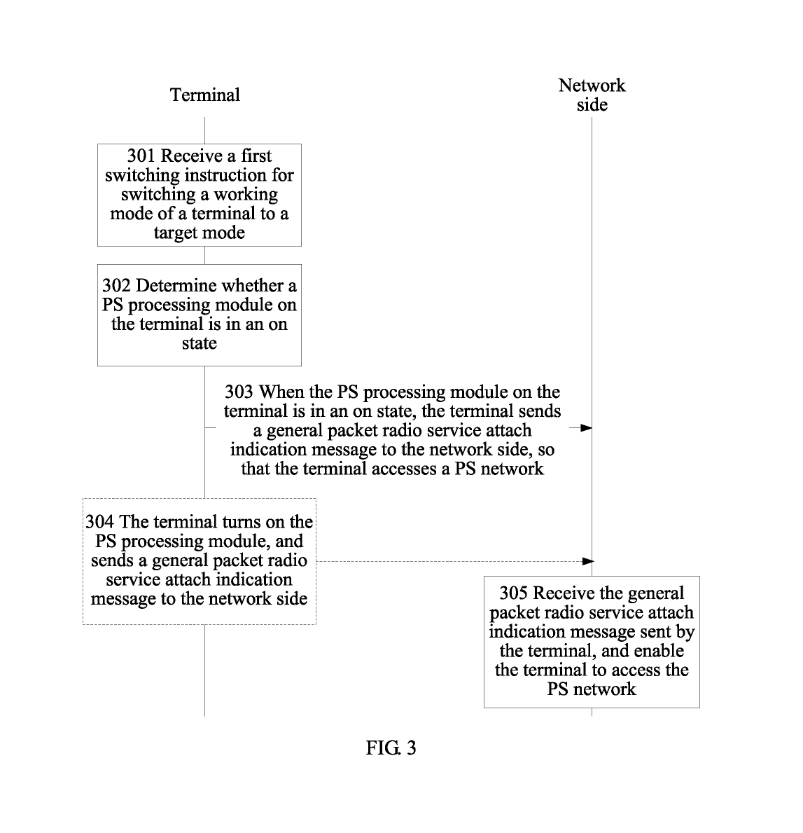

FIG. 3 shows a mode switching method according to still another embodiment of the present invention. For example, before the working mode of the terminal is switched to the target mode, if the working mode of the terminal is a second mode (the second mode is the same as the offline mode in the prior art), where the second mode indicates that the CS domain service is in a disconnected state, and the PS domain service is in a disconnected state, the mode switching method specifically includes the following steps:

301: Receive a first switching instruction for switching a working mode of a terminal to a target mode.

Exemplarily, an option or an icon corresponding to the target mode may be added in a keyboard, a touchscreen or an interface menu of the terminal, where the option or the icon is used to generate a first switching instruction input by a user when the user clicks the option or icon corresponding to the target mode, so that the application layer of the terminal receives the first switching instruction. The application layer of the terminal sends the first switching instruction to the mobility management module of the terminal, so that the mobility management module of the terminal receives the first switching instruction, so as to set the working mode of the terminal to the target mode.

Optionally, when a terminal is in offline mode in the prior art, an option may further be added in a setting menu of the terminal, where the option is used to generate a first switching instruction input by a user when the user selects the option, so that the application layer of the terminal receives the first switching instruction. The application layer of the terminal sends the first switching instruction to the mobility management module of the terminal, so that the mobility management module of the terminal receives the first switching instruction and enables the terminal to access a PS network. In other words, a CS domain service of the terminal is in a disconnected state, and a PS domain service is in a connected state, that is, the working mode of the terminal is switched to the target mode.

An execution subject of this step is the mobility management module, which is existing entity hardware on the terminal.

302: Determine whether a PS processing module on the terminal is in an on state.

Specifically, the mobility management module of the terminal determines whether the PS processing module on the terminal is in an on state.

303: When the PS processing module on the terminal is in an on state, the terminal sends a general packet radio service attach indication message to the network side, so that the terminal accesses a PS network.

Specifically, when the mobility management module of the terminal determines that the PS processing module on the terminal is in an on state, the mobility management module of the terminal sends a general packet radio service attach indication message to the network side, so that the terminal accesses the PS network.

304: When the PS processing module on the terminal is in an off state, the terminal turns on the PS processing module, and sends a general packet radio service attach indication message to the network side, so that the terminal accesses the PS network.

Specifically, when the mobility management module of the terminal determines that the PS processing module on the terminal is in an off state, the mobility management module of the terminal turns on the PS processing module, and sends a general packet radio service attach indication message to the network side, so that the terminal accesses the PS network.

305: The network side receives the general packet radio service attach indication message sent by the terminal, and enables the terminal to access the PS network.

After receiving the general packet radio service attach indication message sent by the terminal, the network side may enable the terminal to access the PS network by using an existing technology.

In the existing technology, when the terminal is switched to an offline mode, by means of the above method, the PS processing module on the terminal is in an on state, and a general packet radio service attach indication message is sent to the network device, so that the terminal accesses the PS network, that is, the terminal is capable of performing the PS domain service.

In this case, the terminal is capable of performing the PS domain service such as web browsing but is incapable of performing the CS domain service such as calls and short messages. A user is free from answering calls or receiving short messages, but may still use data services, for example, the PS domain service such as Internet access and stream media.

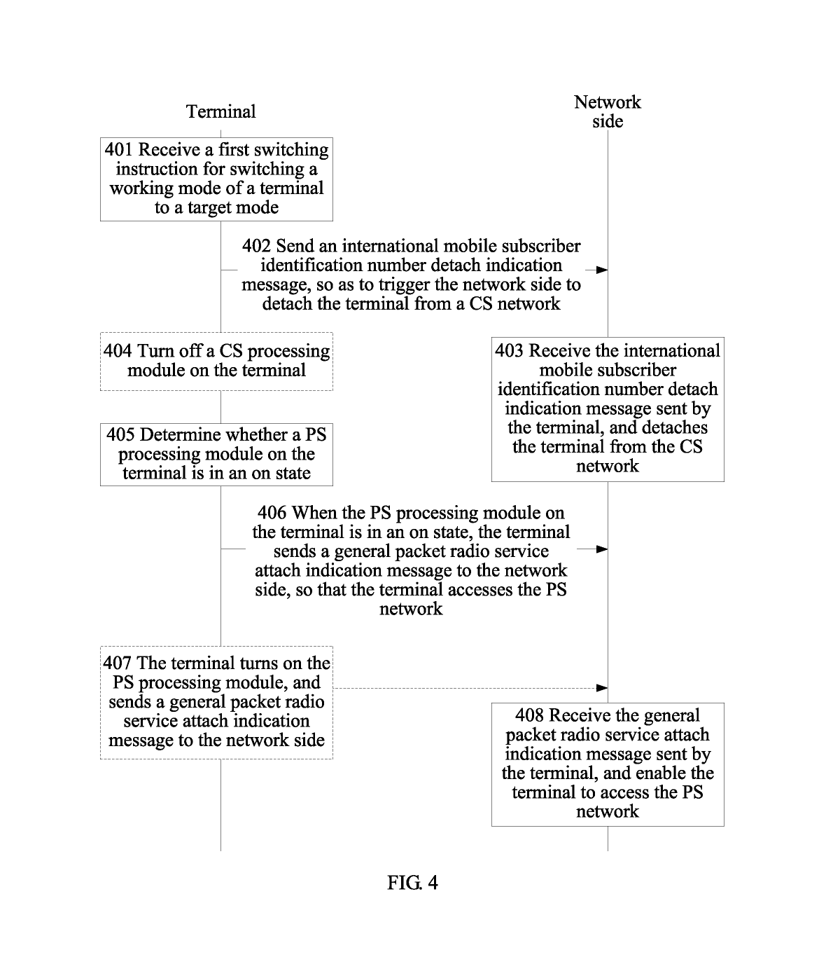

FIG. 4 shows a mode switching method according to still another embodiment of the present invention. In a specific application, for example, before the working mode of the terminal is switched to the target mode, if the working mode of the terminal is a third mode, where the third mode indicates that the CS domain service is in a connected state, and the PS domain service is in a disconnected state, the mode switching method specifically includes the following steps:

401: Receive a first switching instruction for switching a working mode of a terminal to a target mode.

Exemplarily, an option or an icon corresponding to the target mode may be added in a keyboard, a touchscreen or an interface menu of the terminal, where the option or the icon is used to generate a first switching instruction input by a user when the user clicks the option or icon corresponding to the target mode, so that the application layer of the terminal receives the first switching instruction. The application layer of the terminal sends the first switching instruction to the mobility management module of the terminal, so that the mobility management module of the terminal receives the first switching instruction, so as to set the working mode of the terminal to the target mode.

An execution subject of this step is the mobility management module, which is existing entity hardware on the terminal.

402: The terminal sends an international mobile subscriber identification number detach indication message to a network side, so as to trigger the network side to detach the terminal from a CS network.

Specifically, the mobility management module of the terminal sends an international mobile subscriber identification number detach indication message to the network side, so as to trigger the network side to detach the terminal from a CS network.

403: The network side receives the international mobile subscriber identification number detach indication message sent by the terminal, and detaches the terminal from the CS network.

After receiving the international mobile subscriber identification number detach indication message sent by the terminal, the network side may detach the terminal from the CS network using an existing technology.

Optionally, the above step 402 to 403 may be replaced by the following step 404:

404: The terminal turns off a CS processing module on the terminal, so that the terminal is incapable of accessing a CS network.

The mobility management module of the terminal turns off the CS processing module on the terminal, and maintains a PS processing module in an on state.

For the network side, the terminal does not send an IMSI detach indication message to the network side, so the network side does not know that the terminal is incapable of performing the CS domain service. When a call is made to the terminal, the network side gets a response indicating that the call cannot be answered.

405: Determine whether a PS processing module on the terminal is in an on state.

Specifically, the mobility management module of the terminal determines whether the PS processing module on the terminal is in an on state.

406: When the PS processing module on the terminal is in an on state, the terminal sends a general packet radio service attach indication message to the network side, so that the terminal accesses the PS network.

Specifically, when the mobility management module of the terminal determines that the PS processing module on the terminal is in an on state, the mobility management module of the terminal sends a general packet radio service attach indication message to the network side, so that the terminal accesses the PS network.

407: When the PS processing module on the terminal is in an off state, the terminal turns on the PS processing module, and sends a general packet radio service attach indication message to the network side, so that the terminal accesses the PS network.

Specifically, when the mobility management module of the terminal determines that the PS processing module on the terminal is in off state, the mobility management module of the terminal turns on the PS processing module, and sends a general packet radio service attach indication message to the network side, so that the terminal accesses the PS network.

408: The network side receives the general packet radio service attach indication message sent by the terminal, and enables the terminal to access the PS network.

After receiving the general packet radio service attach indication message sent by the terminal, the network side may enable the terminal to access the PS network by using an existing technology.

When the working mode of the terminal is a third mode, where the third mode indicates that the CS domain service is in a connected state, and the PS domain service is in a disconnected state, by means of the above method, the working mode of the terminal may be switched to the target mode.

In this case, the terminal is capable of performing the PS domain service such as web browsing but is incapable of performing the CS domain service such as calls and short messages. A user is free from answering calls or receiving short messages, but may still use data services, for example, the PS domain service, such as Internet access and stream media.

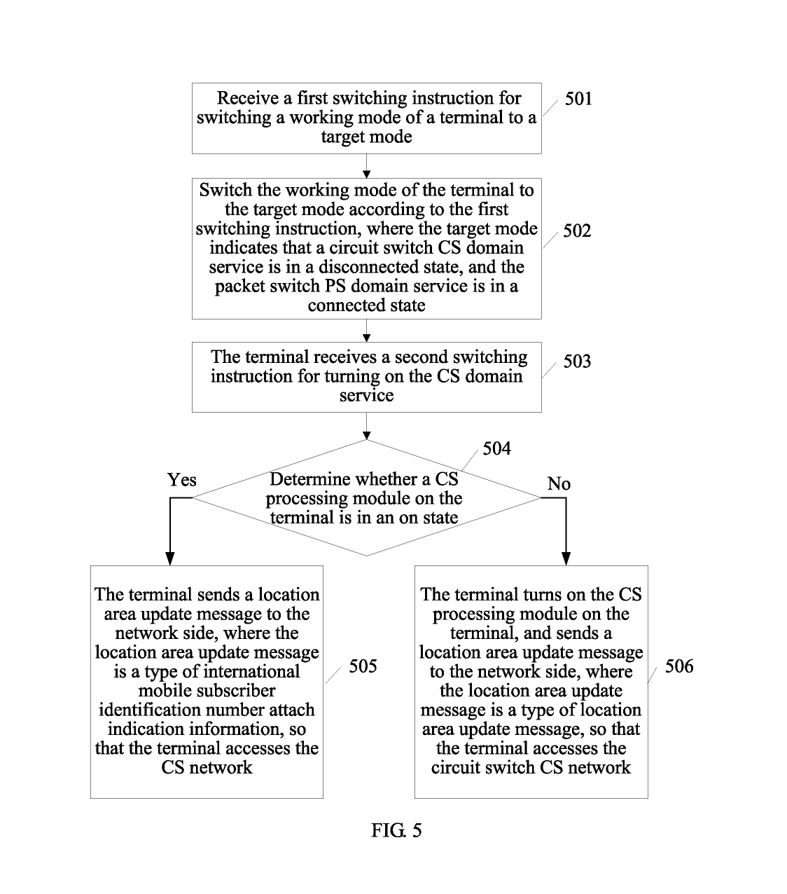

FIG. 5 shows still another mode switching method according to an embodiment of the present invention, which specifically includes the following steps in specific applications:

501: Receive a first switching instruction for switching a working mode of a terminal to a target mode.

Specific implementation of step 501 is the same as that of step 201, step 301 or step 401, and for execution, reference may be made to step 201, step 301 or step 401, which is not described here again.

An execution subject of this step is the mobility management module, which is existing entity hardware on the terminal.

502: Switch the working mode of the terminal to the target mode according to the first switching instruction, where the target mode indicates that a circuit switch CS domain service is in a disconnected state, and a packet switch PS domain service is in a connected state.

After the working mode of the terminal is switched to the target mode, the following steps may be performed:

503: The terminal receives a second switching instruction for turning on the CS domain service.

Exemplarily, an option or an icon corresponding to the first mode may be added in a keyboard, a touchscreen or an interface menu of the terminal, where the option or the icon is used to generate a second switching instruction input by a user when the user clicks the option or icon corresponding to the first mode, so that the application layer of the terminal receives the second switching instruction. The application layer of the terminal sends the second switching instruction to the mobility management module of the terminal, so that the mobility management module of the terminal receives the second switching instruction, so as to set the working mode of the terminal to the first mode. The terminal hence turns on the CS domain service.

Optionally, an option may further be added in a setting menu of the terminal, where the option is used to generate a second switching instruction input by a user when the user selects the option, so that the application layer of the terminal receives the second switching instruction. The application layer of the terminal sends the second switching instruction to the mobility management module of the terminal, so that the mobility management module of the terminal receives the second switching instruction and enables the terminal to access a CS network. In other words, the CS domain service of the terminal is in a connected state, and the PS domain service is maintained in a connected state, that is, the working mode of the terminal is set to the first mode.

An execution subject of this step is the mobility management module, which is existing entity hardware on the terminal.

504: Determine whether a CS processing module is in an on state.

Specifically, the mobility management module of the terminal determines whether the CS processing module on the terminal is in an on state.

505: When the CS processing module on the terminal is in an on state, the terminal sends a location area update message to the network side, where the location area update message is a type of international mobile subscriber identification number attach indication information, so that the terminal accesses the CS network.

The mobility management module of the terminal sends a location area update message to the network side, where the location area update message is a type of an international mobile subscriber identification number attach indication IMSI Attach Indication message, so that the terminal accesses the CS network.

After the location area is successfully updated, the terminal recovers the CS domain service, and may receive calls and short messages.

In the prior art, if the offline mode is turned off, while updating the location area, the terminal further needs to send a GPRS attach indication message to the network side, so that the terminal is capable of performing the PS domain service Unlike the prior art, in the embodiment of the present invention, the PS domain service is maintained in a connected state, so only the CS domain service needs to be recovered.

When the network side receives the international mobile subscriber identification number attach indication message sent by the terminal, the network side may enable the terminal to access the CS network by using an existing technology.

506: When the CS processing module on the terminal is in an off state, the terminal turns on the CS processing module on the terminal, and sends a location area update message to the network side, where the location area update message is a type of a common location area update message, so that the terminal accesses the circuit switch CS network.

The mobility management module of the terminal sends a common location area update message to the network side, so that the terminal accesses the CS network. The terminal turns on the CS processing module on the terminal, and after the location area is successfully updated, the terminal recovers the CS domain service, thereby being capable of receiving calls and short messages.

When the network side receives the common location area update message sent by the terminal, the network side may enable the terminal to access the CS network by using an existing technology.

### Embodiment 2

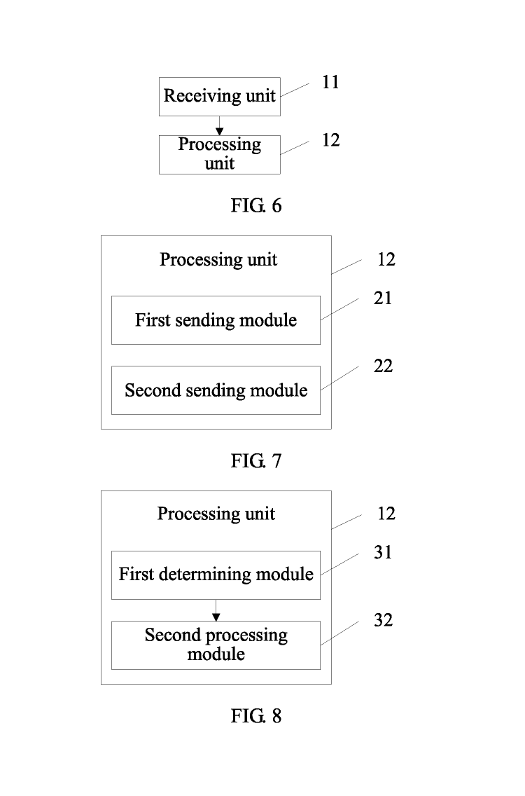

A terminal provided in an embodiment of the present invention is shown in FIG. 6, which includes a receiving unit 11 and a processing unit 12.

The receiving unit 11 is configured to receive a first switching instruction for switching a working mode of a terminal to a target mode.

The processing unit 12 is configured to switch the working mode of the terminal to the target mode according to the first switching instruction, where the target mode indicates that a circuit switch CS domain service is in a disconnected state, and a packet switch PS domain service is in a connected state.

In the terminal provided in the embodiment of the present invention, when the receiving unit receives a first switching instruction for switching a working mode of a terminal to a target mode, the working mode of the terminal is switched to the target mode, where the target mode indicates that a circuit switch CS domain service is in a disconnected state, and a packet switch PS domain service is in a connected state. The embodiment of the present invention solves the problem in the prior art that when a terminal is switched to an offline mode, the terminal is in power-off state relative to a network, so in addition to that calls and short messages in a CS domain service cannot be received, network data services in a PS domain service cannot be used as well, and implements that the terminal is capable of using network data services when being incapable of receiving calls or short messages, thereby improving service experience of users.

As shown in FIG. 7, in the terminal provided in an embodiment of the present invention, the processing unit includes:

a first sending module 21, configured to send an international mobile subscriber identification number detach indication message to a network side, so as to trigger the network side to detach the terminal from a CS network; or,

a first processing module 22, configured to turn off a CS processing module on the terminal, so that the terminal is incapable of accessing the CS network.

Optionally, as shown in FIG. 8, in the terminal provided in an embodiment of the present invention, the processing unit includes:

a first determining module 31, configured to determine whether a PS processing module on the terminal is in an on state; and

a first processing module 32, configured to: when the PS processing module on the terminal is in an on state, enable the terminal to send a general packet radio service attach indication message to a network side, so that the terminal accesses a PS network.

The first processing module is further configured to: when the PS processing module on the terminal is in an off state, enable the terminal to turn on the PS processing module and send a general packet radio service attach indication message to the network side, so that the terminal accesses the PS network.

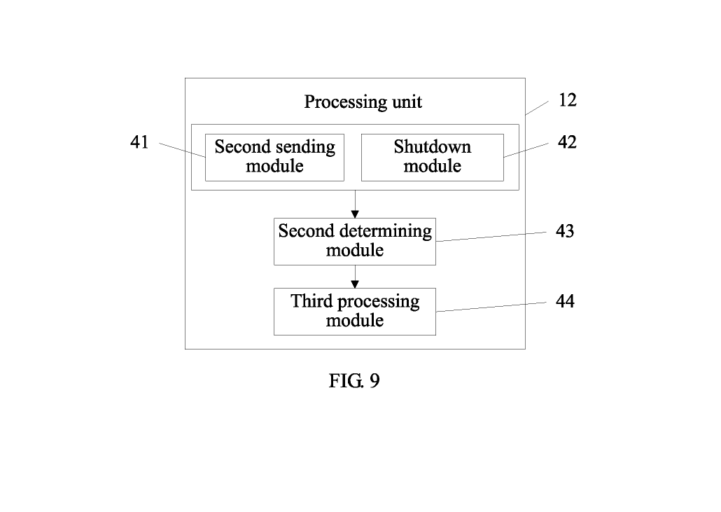

Optionally, as shown in FIG. 9, in the terminal provided in an embodiment of the present invention, the processing unit includes:

a second sending module or a shutdown module, or a combination thereof, where the second sending module 41 is configured to send an international mobile subscriber identification number detach indication message to a network side, so as to trigger the network side to detach the terminal from a CS network;

the shutdown module 42 is configured to turn off a CS processing module on the terminal, so that the terminal is incapable of accessing the CS network;

a second determining module 43, configured to determine whether a PS processing module on the terminal is in an on state; and

a third processing module 44, configured to: when the PS processing module on the terminal is in an on state, enable the terminal to send a general packet radio service attach indication message to the network side, so that the terminal accesses the PS network.

The third processing module is further configured to: when the PS processing module on the terminal is in an off state, enable the terminal to turn on the PS processing module and send a general packet radio service attach indication message to the network side, so that the terminal accesses the PS network.

Optionally, in the terminal provided in the embodiment of the present invention, the receiving unit is further configured to receive a second switching instruction for turning on the CS domain service.

The processing unit is further configured to determine whether the CS processing module on the terminal is in an on state; when the CS processing module on the terminal is in an on state, enable the terminal to send a location area update message to the network side, where the location area update message is a type of international mobile subscriber identification number attach indication information, so that the terminal accesses the CS network; and when the CS processing module on the terminal is in off state, enable the terminal to turn on the CS processing module on the terminal and send a location area update message to the network side, where the location area update message is a type of a common location area update message, so that the terminal accesses the circuit switch CS network.

For an operation process of the terminal, reference may be made to the implementation process of the mode switching method.

The above terminal may be a terminal product such as a mobile phone or a tablet computer.

The foregoing descriptions are merely specific embodiments of the present invention, but are not intended to limit the protection scope of the present invention. Any variation or replacement readily figured out by persons skilled in the art within the technical scope disclosed in the present invention shall fall within the protection scope of the present invention. Therefore, the protection scope of the present invention shall be subject to the protection scope of the claims.

1-10. (canceled)

11. A mode switching method comprising:
receiving a first switching instruction for switching a working mode of a terminal to a target mode; and
switching the working mode of the terminal to the target mode according to the first switching instruction, wherein the target mode indicates that a circuit switch (CS) domain service is in a disconnected state, and a packet switch (PS) domain service is in a connected state.

12. The method according to claim 11, wherein before the working mode of the terminal is switched to the target mode, if the working mode of the terminal is a first mode, and the first mode indicates that the CS domain service is in a connected state, and the PS domain service is in a connected state;
the switching the working mode of the terminal to the target mode according to the first switching instruction comprises:
sending, by the terminal, an international mobile subscriber identification number detach indication message to a network side, so as to trigger the network side to detach the terminal from a CS network; or,
turning off, by the terminal, a CS processing module on the terminal, so that the terminal is incapable of accessing the CS network.

13. The method according to claim 11, wherein before the working mode of the terminal is switched to the target mode, if the working mode of the terminal is a second mode, and the second mode indicates that the CS domain service is in a disconnected state, and the PS domain service is in a disconnected state,
the switching the working mode of the terminal to the target mode according to the first switching instruction comprises:
determining whether a PS processing module on the terminal is in an on state;
if the PS processing module on the terminal is in an on state, sending, by the terminal, a general packet radio service attach indication message to a network side, so that the terminal accesses a PS network; and/or,
if the PS processing module on the terminal is in an off state, turning on, by the terminal, the PS processing module, and sending a general packet radio service attach indication message to the network side, so that the terminal accesses the PS network.

14. The method according to claim 11, wherein before the working mode of the terminal is switched to the target mode, if the working mode of the terminal is a third mode, and the third mode indicates that the CS domain service is in a connected state, and the PS domain service is in a disconnected state,
the switching the working mode of the terminal to the target mode according to the first switching instruction comprises:
sending, by the terminal, an international mobile subscriber identification number detach indication message to a network side, so as to trigger the network side to detach the terminal from a CS network; or,
turning off, by the terminal, a CS processing module on the terminal, so that the terminal is incapable of accessing the CS network;
determining whether a PS processing module on the terminal is in an on state;
if the PS processing module on the terminal is in an on state, sending, by the terminal, a general packet radio service attach indication message to the network side, so that the terminal accesses the PS network; and/or,
if the PS processing module on the terminal is in an off state, turning on, by the terminal, the PS processing module, and sending a general packet radio service attach indication message to the network side, so that the terminal accesses the PS network.

15. The method according to claim 11, after the switching the working mode of the terminal to the target mode, further comprising:
receiving, by the terminal, a second switching instruction for turning on the CS domain service;
determining whether the CS processing module on the terminal is in an on state;
if the CS processing module on the terminal is in an on state, sending, by the terminal, a location area update message to a network side, wherein the location area update message is a type of international mobile subscriber identification number attach indication information, so that the terminal accesses the CS network; and/or,
if the CS processing module on the terminal is in an off state, turning on, by the terminal, the CS processing module on the terminal, and sending a location area update message to the network side, wherein the location area update message is a type of a common location area update message, so that the terminal accesses the CS network.

16. A terminal comprising:
a receiving unit configured to receive a first switching instruction for switching a working mode of a terminal to a target mode; and
a processing unit configured to switch the working mode of the terminal to the target mode according to the first switching instruction, wherein the target mode indicates that a circuit switch CS domain service is in a disconnected state, and a packet switch PS domain service is in a connected state.

17. The terminal according to claim 16, wherein the processing unit comprises:
a first sending module configured to send an international mobile subscriber identification number detach indication message to a network side so as to trigger the network side to detach the terminal from a CS network; or,
a first processing module configured to turn off a CS processing module on the terminal so that the terminal is incapable of accessing the CS network.

18. The terminal according to claim 16, wherein the processing unit comprises:
a first determining module, configured to determine whether a PS processing module on the terminal is in an on state; and
a second processing module, configured to enable the terminal to send a general packet radio service attach indication message to a network side so that the terminal accesses a PS network when the PS processing module on the terminal is in an on state;
wherein the second processing module is further configured to enable the terminal to turn on the PS processing module and send a general packet radio service attach indication message to the network side so that the terminal accesses the PS network when the PS processing module on the terminal is in an off state.

19. The terminal according to claim 16, wherein the processing unit comprises:
a second sending module or a shutdown module, or a combination thereof, wherein the second sending module is configured to send an international mobile subscriber identification number detach indication message to a network side, so as to trigger the network side to detach the terminal from a CS network; the shutdown module is configured to turn off a CS processing module on the terminal, so that the terminal is incapable of accessing the CS network;
a second determining module, configured to determine whether a PS processing module on the terminal is in an on state; and
a third processing module, configured to enable the terminal to send a general packet radio service attach indication message to the network side so that the terminal accesses the PS network when the PS processing module on the terminal is in an on state;
wherein the third processing module is further configured to enable the terminal to turn on the PS processing module and send a general packet radio service attach indication message to the network side, so that the terminal accesses the PS network when the PS processing module on the terminal is in an off state.

20. The terminal according to claim 16, wherein,
the receiving unit is configured to receive a second switching instruction for turning on the CS domain service;
the processing unit is further configured to determine whether the CS processing module on the terminal is in an on state; when the CS processing module on the terminal is in an on state, enable the terminal to send a location area update message network side, wherein the location area update message is a type of international mobile subscriber identification number attach indication information, so that the terminal accesses the CS network; and when the CS processing module on the terminal is in an off state, enable the terminal to turn on the CS processing module on the terminal and send a location area update message to the network side, wherein the location area update message is a type of a common location area update message, so that the terminal accesses the CS network.
